(19) United States
(12) Patent Application Publication
(10) Pub. No.: US 2016/0171446 A1
(43) Pub. Date: Jun. 16, 2016

(54) Professional, Career, and Academic Scoring

(71) Applicant: VectorScore, Inc., Atlanta, GA (US)

(72) Inventors: Justin Jeffrey Gandino-Saadein, Covington, GA (US); Oscar Morales, FPO, AP (US)

(73) Assignee: VectorScore, Inc., Atlanta, GA (US)

(21) Appl. No.: 14/841,705

(22) Filed: Sep. 1, 2015

Related U.S. Application Data
(60) Provisional application No. 62/156,972, filed on May 5, 2015.

(51) Int. Cl. G06Q 10/10; G06F 17/30

(52) U.S. Cl. CPC G06Q 10/1053; G06F 17/3053

(57) ABSTRACT

Techniques for professional, career, and academic reporting and scoring are disclosed. In some embodiments, professional, career, and academic reporting and scoring includes collecting information associated with an entity; and generating a professional, career, and academic report and score based on public or private information associated with the entity. In some embodiments, professional, career, and academic scoring further includes outputting the professional, career, and academic report and score. In some embodiments, professional, career, and academic reporting and scoring includes determining professional, career, and academic information that was collected that is associated with the entity.

### CROSS-REFERENCE TO RELATED APPLICATIONS

This application claims the benefit of U.S. Provisional Application No. 62/156,972, filed May 5, 2015.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB) Not Applicable

### STATEMENT REGARDING PRIOR DISCLOSURES BY THE INVENTOR OR A JOINT INVENTOR

Not Applicable

### BACKGROUND OF THE INVENTION

The present invention is in the technical field of talent management. More particularly, the present invention is in the technical field of recruiting. The invention relates generally to a technique or process related to outputting a report or a dynamic alpha-numeric or numeric representation of an analysis of contextual, quantifiable, and qualified data collected from professional, career, and academic information associated with an embodiment. More specifically, this report or alpha-numeric or numeric representation, similar to a credit score, is reflective of all professional, career, and academic informational of an embodiment when the report or score is generated.

### BRIEF SUMMARY OF THE INVENTION

The job, talent, or student acquisition process is typically initiated with an embodiment, candidate, submitting a document, resume, curriculum vitae, or profile, electronically or physically, to a database or program (system). The document is processed through a system, automated or manual, and is subjectively reviewed by an individual, or automated process, to qualify the embodiment for further progression in the job, talent, or student acquisition process—typically an interview.

The document processing, or resume intake, is inefficient, time and resource consuming, and does not include any quantifiable metric or baseline for candidate comparison. Recruiters, hiring manager, and admissions panels (system), make subjective assessments of the document, resume, curriculum vitae, or profile, and assess whether the candidate is qualified to further progress in the job, talent, or student acquisition process.

Systems exist to analyze and organize the context of the document, resume, curriculum vitae, or profile, but no system exists to simplify, standardize, and represent the contextual, quantifiable, and qualified data of an embodiment. The present invention seeks to provide a process to drive an output of a dynamic alpha-numeric or .numeric representation, regardless of the number of characters, that is reflective of an analysis of contextual, quantifiable, and qualified data to set a baseline of measure for an embodiment submitting a document, resume, curriculum vitae, or profile, electronically or physically, to a system for the purpose of applying or applying or requesting for a job, position of employment (paid or unpaid), casual or occasional work, public office or position of trust, or admission or association to an institution or program.

### BRIEF DESCRIPTION OF THE SEVERAL VIEWS OF THE DRAWINGS

Various embodiments of the invention are disclosed in the following detailed description and the accompanying drawings.

FIG. 1 illustrates a functional block diagram of a computing environment for professional, career, and academic scoring in accordance with some embodiments.

FIG. 2 illustrates an example of components included in a professional, career, and academic platform in accordance with some embodiments.

FIG. 3 illustrates an embodiment of a process for enrolling an entity with a professional, career, and academic scoring platform in accordance with some embodiments.

FIG. 4 illustrates another example of components included in a scoring platform in accordance with some embodiments.

FIG. 5 illustrates a flow diagram of a process for refreshing collected professional, career, and academic information data in accordance with some embodiments.

FIG. 6 illustrates an example of components included in a scoring platform that performs professional, career, and academic reporting in accordance with some embodiments.

FIG. 7 illustrates an example of an interface as rendered in a browser of a professional, career, and academic in accordance with some embodiments.

FIG. 8 illustrates a flow diagram process for professional, career, and academic reporting in accordance with some embodiments.

FIG. 9 illustrates an example of components included in a scoring platform that performs professional, career, and academic scoring in accordance with some embodiments.

FIG. 10 illustrates an examples of an interface as rendered in a browser of a professional, career, and academic report with a professional, career, and academic score in accordance with some embodiments.

FIG. 11 illustrates a flow diagram in a process for professional, career, and academic scoring in accordance with some embodiments.

### DETAILED DESCRIPTION OF THE INVENTION

The invention can be implemented in numerous ways, including as a process; an apparatus; a system; a composition of matter; a computer program product embodied on a computer readable storage medium; and/or a processor, such as a processor configured to execute instructions stored on an/or provided by a memory coupled to the processor. In this particular specification, these implementations, or any other form there the invention may take, may be referred to as techniques. In general, the order of the steps disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured. Individuals are increasingly frustrated with the application process, whether the application is for admission into an academic program or to start work with a new company. Additionally, individuals who have to review and screen applications are increasingly frustrated with the inefficiency and subjectivity applied to applications which can change from day to day. For example, individuals create a resume or online profile and submit this application to database. When the information is submitted to a database, it contains information in a multitude of organizational layouts, and no way exists to quantify this information to compare applications without bias.

What are needed are new and improved techniques for entities, such as users and/or other entities, to create an alpha-numeric string, similar to credit score, that allows an entity to compare one application to another without bias and subjectivity. Accordingly, techniques for professional, career, and academic scoring are disclosed. In some embodiments, professional, career, and academic scoring includes collecting information associated with an entity; and generating a professional, career, and academic score based on public and private information that was collected that is associated with the entity. In some embodiments, professional, career, and academic scoring further includes determining professional, career, and academic information that was collected that is associated with the entity.

In some embodiments, professional, career, and academic scoring further includes outputting the professional, career, and academic score. In some embodiments, professional, career, and academic scoring further includes outputting a professional, career, and academic report that includes the professional, career, and academic score. In some embodiments, professional, career, and academic scoring further includes outputting a professional, career, and academic report that includes the professional, career, and academic score, wherein the professional, career, and academic score corresponds to an overall professional, career, and academic score. In some embodiments, professional, career, and academic scoring further includes outputting a professional, career, and academic report that includes the professional, career, and academic score and a recommendation to improve the professional, career, and academic score. In some embodiments, professional, career, and academic scoring further includes alerting the entity based on the professional, career, and academic score. In some embodiments, professional, career, and academic scoring further includes periodically collecting information associated with the entity; and updating the professional, career, and academic score. In some embodiments, professional, career, and academic scoring further includes periodically collecting information associated with the entity; updating the professional, career, and academic score; and alerting the entity that the professional, career, and academic score has been updated.

In some embodiments, professional, career, and academic scoring further includes verifying that the public or private information is associated with the entity (e.g., based on entity feedback and/or using various other techniques, such as described herein). In some embodiments, professional, career, and academic scoring further includes verifying that the public or private information is associated with the entity and is professional, career, and academic data (e.g., based on entity feedback and/or using various other techniques, such as described herein).

In some embodiments, professional, career, and academic scoring further includes periodically collecting information associated with the entity. In some embodiments, professional, career, and academic scoring further includes collecting information associated with the entity using an application programming interface to request data from a third party data source (e.g., to collect structured data related to the entity). In some embodiments, professional, career, and academic scoring further includes collecting information associated with the entity using a site scraper to extract data from a web site (e.g., to collect unstructured data related to the entity). In some embodiments, professional, career, and academic scoring further includes collecting information associated with the entity using a search engine to extract data from a plurality of web sites (e.g., to collect unstructured data related to the entity).

### Scoring Platform

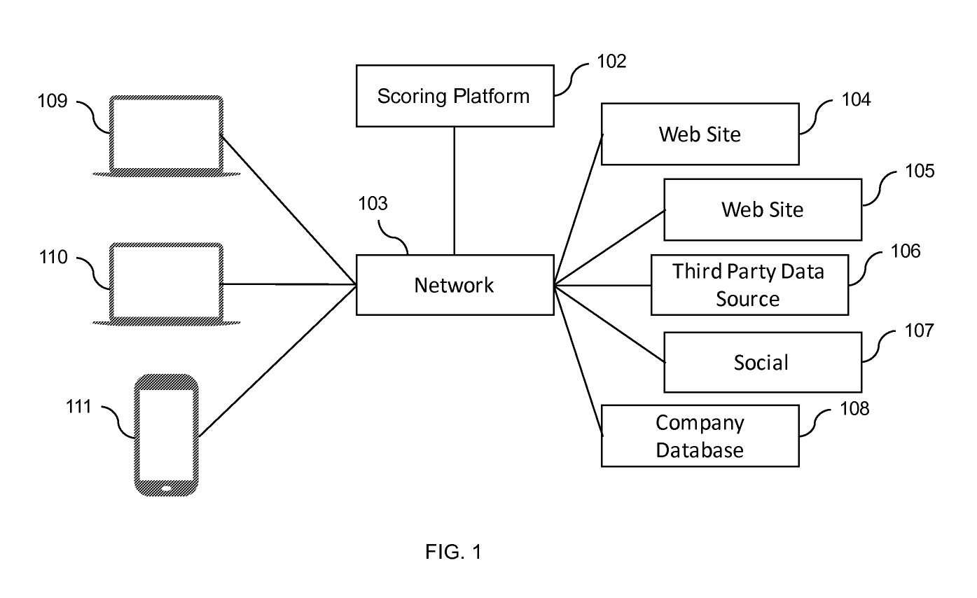

FIG. 1 illustrates a functional block diagram of a computing environment for professional, career, and academic reporting in accordance with some embodiments. In particular, FIG. 1 illustrates an environment in which professional, career, and academic information of an entity (e.g., a user) is collected, analyzed, and presented.

For example, a professional, career, and academic report can be output to a user. The professional, career, and academic report can provide an analysis of the user's digital footprint (e.g., exposed user related data on the Internet and other publicly or privately available data sources) and analyze their exposed professional, career, and academic data (age, birth date, social security number, and/or other personal, confidential, or sensitive information), such as what data is available, where such professional, career, and academic information is available, how it was available (e.g., to potentially infer that such data may have been available when the user signed up with an account or was employed with a particular third party entity), and/or what it is being used for (e.g., employment, academic activities, and/or other activities). The professional, career, and academic report can also include recommendations to the user to improve their professional, career, and academic competitiveness.

As another example, a professional, career, and academic score (e.g., professional, career, and academic report that includes a professional, career, and academic score) can be output to a user. The professional, career, and academic score can provide a score that is based on a professional, career, and academic analysis of the user's digital footprint (e.g., exposed user related data on the Internet and other publicly or privately available data sources) and analyze their exposed professional, career, and academic data (age, birth date, social security number, and/or other personal, confidential, or sensitive information). For example, the professional, career, and academic score can be provided along with the professional, career, and academic report or as part of the professional, career, and academic report to provide the user with an alpha-numeric measure and to facilitate the user being able to gauge their professional, career, and academic data competitiveness and insight. The professional, career, and academic report can also include recommendations to the user to improve their professional, career, and academic score and improve their professional, career, and academic competitiveness.

In the example shown, the user of client device 109 (hereinafter referred to as “David”) owns his own business (“David's Company”). The user of client device 110 (hereinafter referred to as “Helen”) is employed by a national company (“Widget Company”). As will be described in more detail below, David and Helen can each access the services of scoring platform 102 via network 103, such as the Internet, to determine the professional, career, and academic score of an entity. The techniques described herein can work with a variety of client devices 109-111 including, but not limited to personal computers, tablet computers, smartphones, and/or other computing devices.

In some embodiments, scoring platform 102 is configured to collect personal data and other data determined to be potentially associated with a user from a variety of sources, including websites 104-105, third party data sources 106, social networking websites 107, and other public or private sources, such as a company database 108. In some embodiments, users of the scoring platform 102, such as David and Helen, can also provide user related data to scoring platform 102, such as their full legal name, residence address(es), email address(es), phone number(s), employment information, age, birth date, and/or other personal or identifying information that can be used by the scoring platform to identify information that may be associated with the user (e.g., to perform targeted data collection and private data isolation as further described herein). In the examples described herein, web sites 104-105 can be any form of web site that can include content about entities, such as users, associations, corporations, government organizations, and/or other entities. Examples of social networking sites 107 include LinkedIn, Indeed.com, Monstor.com, and Facebook. In some examples, social networking sites 107 can allow users to take actions such as providing employment and academic history. Finally, third party data source 106 and company database 108 are examples of other types of websites or data sources that can include information that may be considered public or private by a user or other entity.

Platform 102 is illustrated as a single logical device in FIG. 1. In various embodiments, platform 102 is a scalable, elastic architecture and may comprise several distributed components, including components provided by one or more third parties. Further, when platform 102 is referred to as performing a task, such as storing data or processing data, it is to be understood that a sub-component or multiple sub-components of platform 102 (whether individually or in cooperation with third party components) may cooperate to perform that task.

### Account/Entity Setup

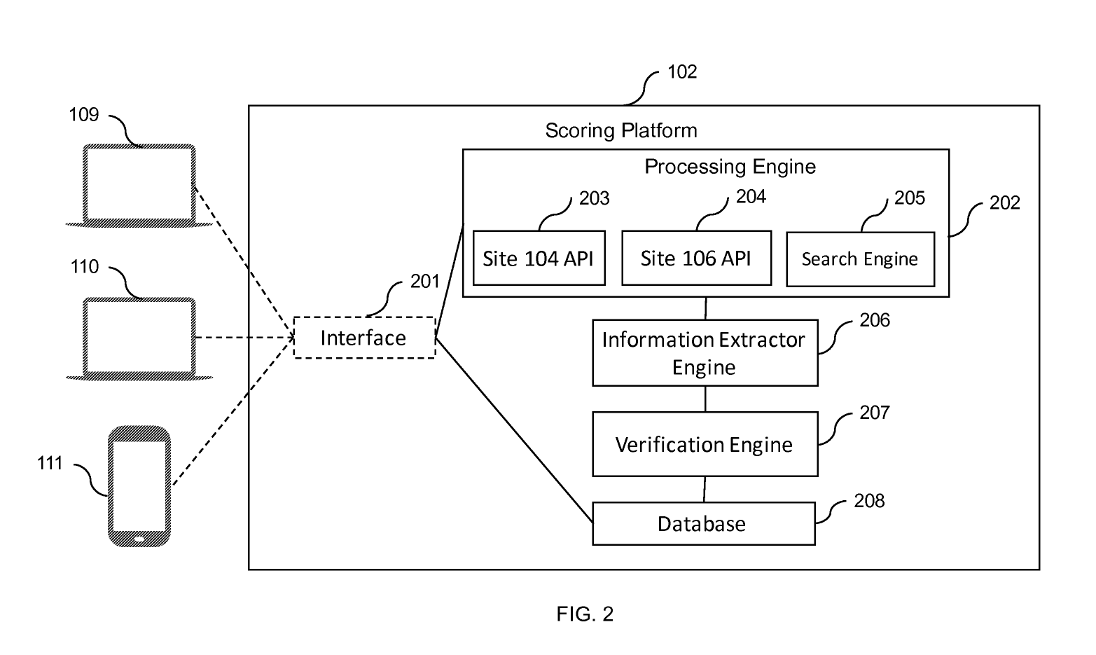

FIG. 2 illustrates an example of components included in a scoring platform in accordance with some embodiments. In particular, FIG. 2 illustrates components of platform 102 that are used in conjunction with a new entity setup process.

For example, in order to access the services provided by scoring platform 102, David first registers for an account with the platform. At the outset of the process, he accesses interface 201 (e.g., a web-based interface) and provides information such as a desired username and password for his new account with the platform. He also provides payment information (if applicable). If David has created accounts for, for example, himself, his family, and/or his business on social networking sites such as sites 107, David can identify those accounts to platform 102 as well. In some cases, David can call the service provider to register and/or setup accounts via a telephony based registration/account set-up process.

Next, David is prompted by platform 102 to provide the name of the entity that he wants to perform the scoring platform services for, which in this case, it is assumed that this would be for himself, such that David can input his full legal name (e.g., “David Jones”), his personal residence address (e.g., “123 Maple Ln.; Norfolk, Ga. 30324), and (optionally) the type of information that he deems to be public or private information (e.g., birthdate, social security number, education information, salary information, and/or other information). This information entered by David is provided to processing engine 202, which is configured to locate, access, and import metadata on the Internet (e.g., World Wide Web) and/or various other online third party data sources, any information that is determined to be associated with David, if present. The data collection performed by processing engine can include structured data collection and unstructured data collection. For example, web sites 104-105 can be identified to have information potentially associated with David based on content analysis (e.g., using various natural language processing techniques). In some embodiments, a search engine, such as Bing, Google, and/or Yahoo, is used to identify URLs of particular web sites that include relative content using search interface 205 of auto find engine 202.

In the example shown in FIG. 2, web site 104 and third party data source 106 make available respective application programming interfaces (APIs) 203 and 204 that are usable by processing engine 202 to locate information that is potentially associated with entities such as David on their sites. Site 105 does not have a profile finder API. In order to locate information that is potentially associated with entities there, processing engine 202 is configured to perform a site-specific search using a script that accesses a search engine (e.g., through search interface 210). As one example, a query of: “site:www.examplesite.com ‘David Jones’Norfolk” could be submitted to the Google search engine using interface 205.

In some embodiments, information extractor engine 206 extracts professional, career, and academic information from the information that is collected by processing engine 202. For example, structured information can be processed (e.g., based on fields of the structured data) to extract potentially relevant private information associated with David. In addition, unstructured information can be processed (e.g., using content based analysis techniques) to extract potentially relevant private information associated with David.

In some embodiments, results obtained by information extractor engine 206 are provided to verification engine 207, which confirms whether such information is associated with the entity of interest, which is David in this example. In some embodiments, verification engine 207 also determines whether such information includes public or private information associated with the entity of interest, which is David in this example. Verification engine 207 can be configured to verify all results (including any obtained from sources 104-108), and can also be configured to verify (or otherwise process) just those results obtained via interface 205. As one example, for a given query, the first ten results obtained from search interface 205 can be examined. The result that has the best match score and also includes the expected entity name and physical address is designated as potentially relevant information on the queried site. As another example, based on verification and entity feedback, the collection process can be iteratively performed to execute more targeted data collection and public or private information extraction based on the verification and entity feedback to improve results (e.g., refined searches can be performed using the search interface 205 in subsequent iterations of the data collection and public and private information extraction process).

In some embodiments, verification engine 207 presents results to David for verification that the potentially public or private information corresponds to information that is associated with David. In some embodiments, verification engine 207 also presents results to David for verification that the potentially private information includes David's public or private information. As an example, David may be shown (via interface 201) a set of URLs on each of the.sites 104-105 and extracted information from such URLs that were previously determined by information extractor engine 206 and processing engine 202 to including potentially public or private professional, career, and academic information associated with David. Once confirmed by David, the source (e.g., URLs, third party data source, company information, and/or other source identifying information) along with the verified public or private information (e.g., extracted from the third party data source), professional, career, and academic information, and any other appropriate data are stored in database 208. Examples of such other data can include information associated with the data source (e.g., classification of the data source, reputation of the data source, prominence of the data source, and/or other information) and/or any social data (e.g., obtained from social sites 107).

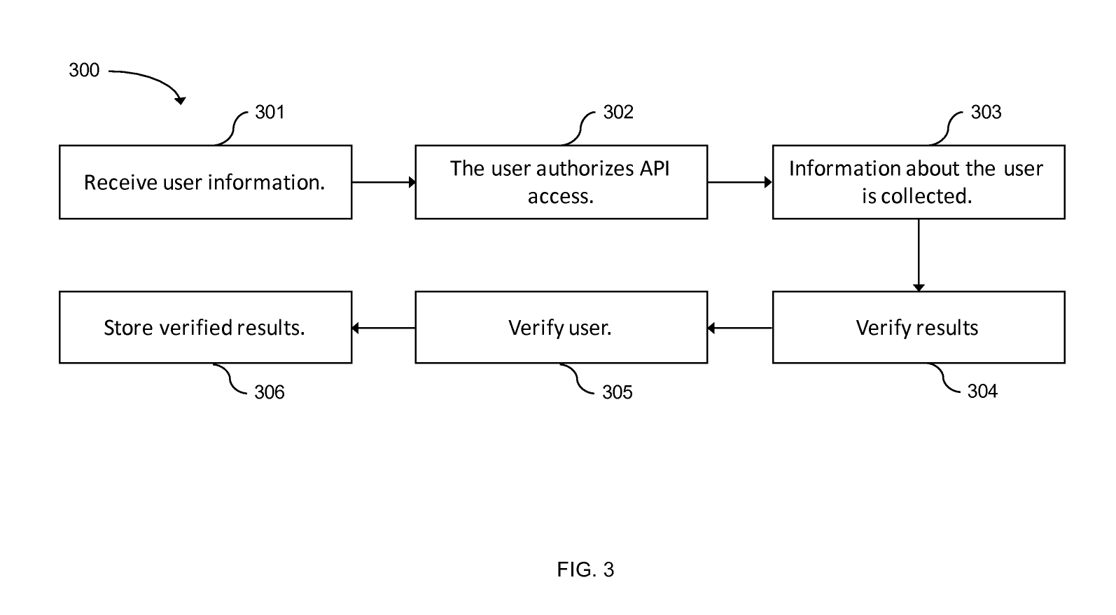

FIG. 3 illustrates an embodiment of a process for enrolling an entity with a scoring platform in accordance with some embodiments. In some embodiments, process 300 is performed by platform 102 for enrolling an entity for the professional, career, and academic reporting service and/or professional, career, and academic scoring service, such as a new user. The process begins at 301 when user information is received. As one example, when David provides his user information, as similarly discussed above, to platform 102 via interface 201, and that user information is received at 301. At 302-303, the received user information is used to collect potentially relevant public or private professional, career, and academic information associated with the user, which is David in this example. As an example of the processing performed at 303, the received user name is provided to site 104 using API 203. As another example, a site-specific query (e.g., of site 105) is submitted to a search engine via search interface 205. As yet another example, a search query (e.g., of the Internet) is submitted to a search engine via search interface 205.

At 304, results of the public or private personal, professional, career, and academic information data collection performed at 303 are verified. As one example of the processing performed at 303, verification engine 207 performs checks such as confirming that various user information received at 301 is present in a given result (e.g., using content analysis techniques and threshold matching techniques). As another example, a user can be asked to confirm that results are associated with the user and that public or private personal, professional, career, and academic information is included in such results, and if so, that confirmation is received as a verification at 304. Finally, at 306, verified results are stored. As an example, source identifiers (e.g., URLs or other source identifying information) for each of the verified results are stored in database 208. Although pictured as a single database in FIG. 2, in various embodiments, platform 102 makes use of multiple storage modules, such as multiple databases. Such storage modules may be of different types. For example, user account and payment information can be stored in a MySQL database or another data store, while extracted private information (described in more detail below) can be stored using MongoDB, Parse, or another data store. In some embodiments, extracted private information is only temporarily stored (e.g., in memory, such as using an in-memory database) to provide sufficient time for the scoring platform 102 to generate and output a professional, career, and academic report and/or a professional, career, and academic report with a professional, career, and academic score to the entity, such as to provide that output to David, as further described herein.

### Data Collection and Processing

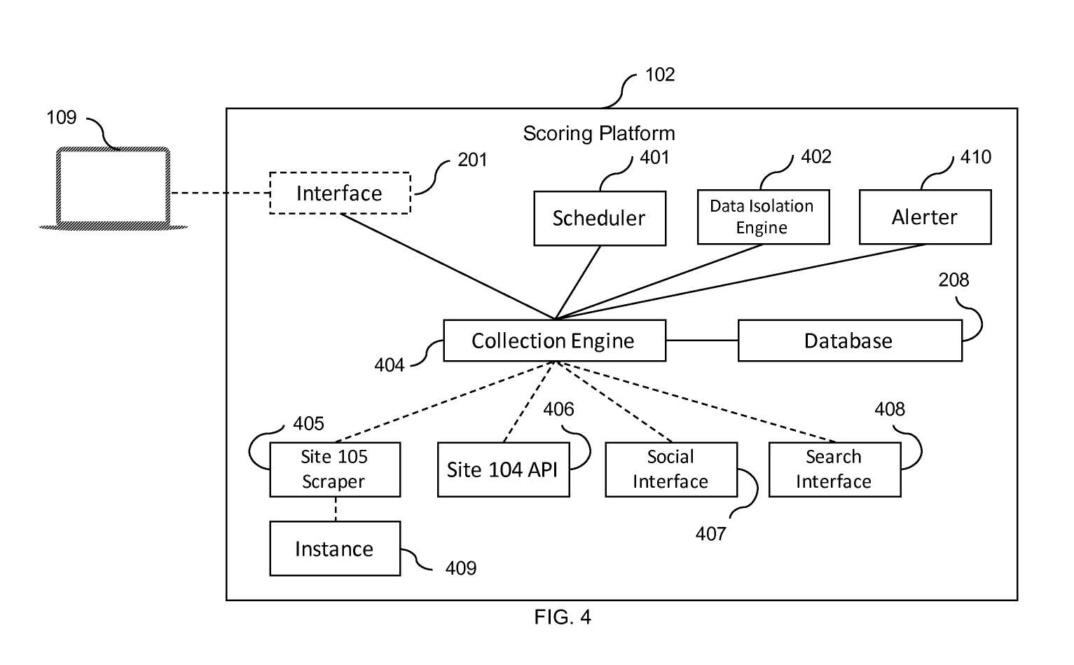

FIG. 4 illustrates another example of components included in a scoring platform in accordance with some embodiments. In particular, FIG. 4 illustrates components of platform 102 that are used in conjunction with the ongoing collection and processing of data. In some embodiments, once an entity (e.g., David Jones) has an account on scoring platform 102, collecting and processing of potentially relevant public, private, personal, professional, career, and academic data is performed. As shown, platform 102 includes a scheduler 401 that periodically instructs collection engine 404 to obtain data from sources such as sources 104-108. Scheduler 401 can be configured to initiate data collection based on a variety of rules. For example, it can cause data collection to occur once a day for all customers (e.g., enrolled entities) across all applicable sites. It can also cause collection to occur with greater frequency for certain entities (e.g., which pay for premium services) than others (e.g., which have free accounts). Further, collection can be performed across all sources (e.g., sources 104-108) with the same frequency or can be performed at different intervals (e.g., with collection performed on site 104 once per day and collection performed on site 105 once per week).

In addition to or instead of the scheduled collection of data, data collection can also be initiated based on the occurrence of an arbitrary triggering event. For example, collection can be triggered based on a login event by a user such as David (e.g., based on a permanent cookie or password being supplied). Collection can also be triggered based on an on-demand refresh request by the user (e.g., where David clicks on a “refresh my data” button in interface 201).

In some embodiments, professional, career, and academic data isolation engine 402 performs extraction of potentially public or private information associated with an entity. In some embodiments, the professional, career, and academic data isolation engine extracts public or private information from structured data sets and from unstructured data sets using various techniques. For example, structured data set analysis can be performed using fields, such as name, address, past address, birth date, work history, education level, social security number, salary information, and so forth. As another example, unstructured data set analysis can be performed using various natural language processing (NLP) and contextual analysis techniques to perform entity extraction; determine associations with a particular entity, like performance history (e.g., promoted ahead of peers); perform inferences; and use verification techniques (e.g., including a user based feedback verification). In some embodiments, the verification provides a feedback loop that can be used by the public or private data isolation engine to become more accurate to provide refined data collection and professional, career, and academic data isolation for a given entity. In some embodiments, the professional, career, and academic data isolation engine includes a classifier engine.

In some embodiments, extracted structural data is used to facilitate identifying a user such as David, and the structured data can then be used to filter the unstructured data using various techniques described herein. For example, David can initially provide the platform with relevant user information (e.g., David, Norfolk, Ga. and possibly other information). The collection engine of the platform can send requests to third party data sources (e.g., Hadoop and/or other sources) using API based queries based on such relevant user information. The platform receives back structured data set results based on such queries. The professional, career, and academic data isolation engine of the platform can isolate information that is relevant to the user and provide that as input to the collection engine, which can then perform web based crawling and/or targeted searches using search engine(s) to collect additional data that may be relevant to the user, in which such additionally collected information can include structured data and unstructured data. The professional, career, and academic data isolation engine of the platform can also isolate information that is relevant to the user from such structured data and unstructured data. The professional, career, and academic data isolation engine can further process the isolated information determined to be relevant to the user to extract and store (e.g., at least temporarily) potentially professional, career, and academic data determined to be associated with the user. In some embodiments, the verification engine can verify whether the potentially professional, career, and academic data is associated with David and may include public or private information associated with David (e.g., which can also include user feedback from David based on the extracted results). The verified results can then be used to generate a professional, career, and academic report and/or a professional, career, and academic report with a professional, career, and academic score for David as further described herein. In some embodiments, such collected and extracted information is stored temporarily (e.g., in memory) for analysis, processing, and reporting purposes but need not be stored permanently or archived for longer periods of time.

In some embodiments, the professional, career, and academic data isolation engine also ranks sources. For example, a source that is more prominent or widely accessed can be given a higher rank than a less prominent source (e.g., a Google search result on page 1 can be deemed more prominent than a Google search result on page 100, and a Google search result can be deemed more prominent than a less widely used source, such as a particular individual's personal blog). The ranking of the source can be relevant information that is identified in a professional, career, and academic report and/or used as a factor or weighting factor in calculating a professional, career, and academic score that is generated and output to the user.

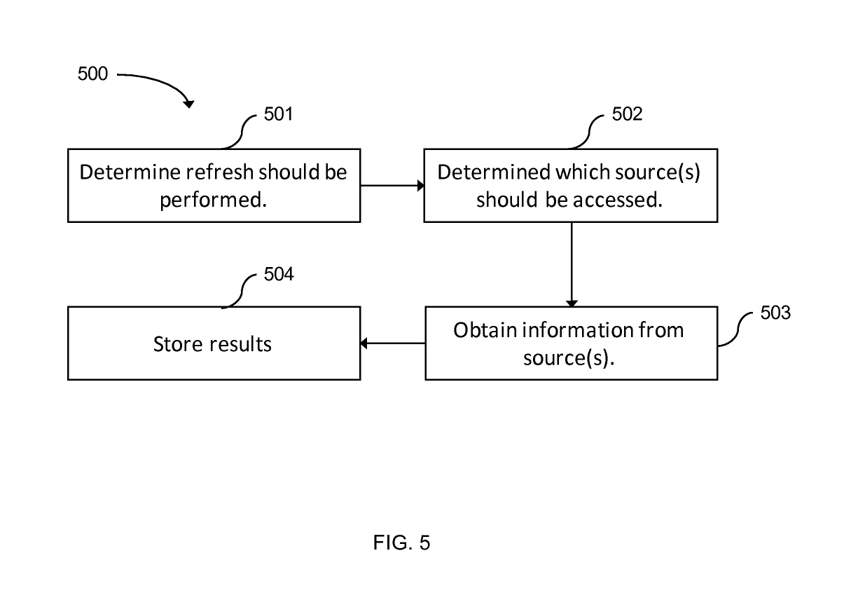

Other elements depicted in FIG. 4 will be described in conjunction with process 500 shown in FIG. 5.

FIG. 5 illustrates a flow diagram of a process for refreshing collected private information data in accordance with some embodiments. In some embodiments, process 500 is performed by platform 102. The process begins at 501 when a determination is made that a data refresh should be performed. As an example, such a determination is made at 501 by scheduler 401 based on an applicable schedule. As another example, such a determination is made at 501 when a triggering event (e.g., a login event by David or another triggering event, such as David clicks a “refresh my data” button using interface 201) is received by platform 102.

At 502, a determination is made as to which sources should be accessed. As an example, collection engine 404 can review a set of stored sources in database 208 for David based on a prior public private information data collection process executed for David. The set of stored sources associated with David are the ones that will be used by collection engine 404 during the refresh operation. As previously mentioned, a refresh can be performed on behalf of multiple (or all) entities, instead of an individual one such as David. In such a scenario, portion 502 of the process can be omitted as applicable. In some embodiments, additional sources can also be accessed during a refresh operation and such sources need not be limited to the set of previously identified set of sources associated with David based on a prior data collection operation for David.

At 503, information is obtained from the sources determined at 502. As shown in FIG. 4, collection engine 404 makes use of several different types of source data collection engines 420-428. Each source data collection engine (e.g., source data collection engine 420) is configured with instructions to fetch data from a particular type of source. As an example, data can be scraped from a source (e.g., a web site) by platform 102 using a site scraper. In particular, when a determination is made that public or private information associated with David on site 104 should be refreshed by platform 102, an instance 409 of source data collection engine 405 is executed on platform 102. Instance 409 is able to extract potentially public or private data on site 110 using site scraper 110. Source data collection engine 405 is configured with instructions for scraping potentially professional, career, and academic score data from site 105 using site scraper 105. Site 104 has made available an API for obtaining potentially private data and source data collection engine 406 is configured to use that API.

Other types of source data collection engines can extract other types of data and/or communicate with other types of sources. As an example, source data collection engine 407 is configured to extract potentially professional, career, and academic score data from social site 107 using an API provided by site 107, such as a LinkedIn, which is a person search site that provides API to pass a person's name and their professional history (e.g., David Jones, Norfolk, Ga., Widget Inc., 2010-2015) to get their previously collected data. As another example, when an instance of source data collection engine 408 is executed on platform 102, a search is performed across the World Wide Web for Indeed.com, Monster.com, or other web pages that may discuss potentially professional, career, and academic score data associated with David. In some embodiments, additional processing is performed on any results of such a search, such as content analysis to verify whether such information is associated with David and whether such information includes potentially relevant private information associated with David.

In various embodiments, information, obtained on behalf of a given entity such as David (or David's Company) or Helen (or Widget Company), is retrieved from different types of sites in accordance with different schedules. For example, while general web site data can be collected hourly, or on demand, social data (collected from sites 104-108) can be collected once a day. Data can be collected from sites on the open Web (e.g., web sites, career web sites, blogs, forums, and/or other sites) once a week.

At 504, any new results (i.e., those not already present in database 208) are stored in database 208. As needed, the results are processed prior to being included in database 208. In various embodiments, database 208 supports heterogeneous records and such processing is omitted or modified as applicable.

Prior to the first time process 500 is executed with respect to David, no previously collected professional, career, and academic score information data associated with David is present in database 208. Portion 503 of the process is performed for each of the data sources applicable to David (via instances of the applicable source data collection engines), and the collected data is stored at 504. On subsequent refreshes of data pertinent to David, only new/changed information is added to database 208. In various embodiments, alerter 410 provides an alerting engine that is configured to alert David (e.g., via an email message, phone call, text message, or another form of communication) whenever process 500 (or a particular portion thereof) is performed with respect to his account. In some cases, alerts are only sent when new professional, career, and academic score information associated with David is collected, and/or when professional, career, and academic scores associated with David (described in more detail below) change, or change by more than a threshold amount.

### Professional, Career, and Academic Score Reporting

Platform 102 is configured to generate a variety of professional, career, and academic reports on behalf of entities including users, such as David and Helen, and businesses or other entities, such as David's Company and Widget Company. As will be described in more detail below, the professional, career, and academic reports provide users with perspective on whether their private information is available online or in the possession of third parties. For example, a professional, career, and academic report can detail what public, private, professional, career, and academic information associated with David is available online or in the possession of third parties, where such public or private information is available, who has access to such private information, and possibly an intended use by third parties who are determined to have access to such public, private, professional, career, and academic information.

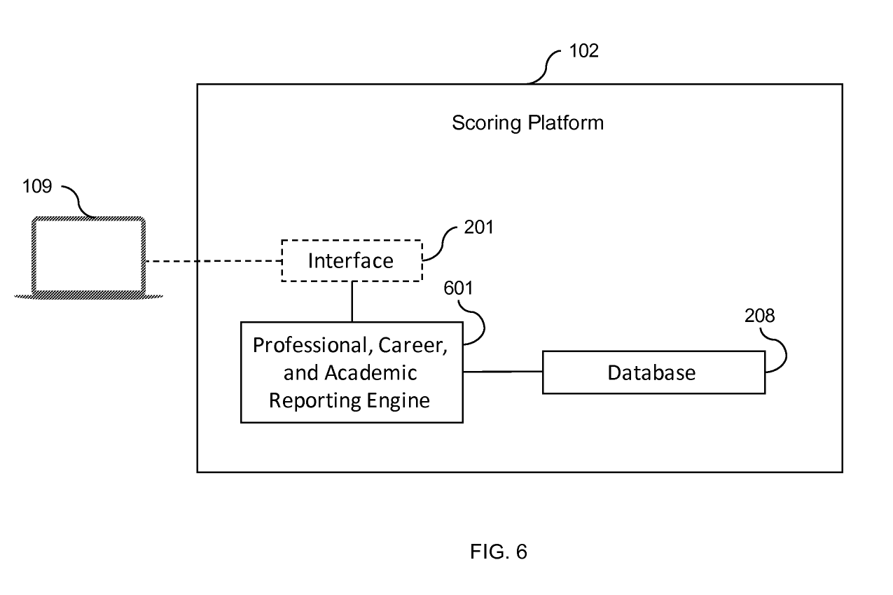

FIG. 6 illustrates an example of components included in a scoring platform that performs public or private reporting in accordance with some embodiments. In particular, FIG. 6 illustrates components of platform 102 that are used in conjunction with generating professional, career, and academic reports. In some embodiments, platform 102 includes a professional, career, and academic reporting engine 602 that generates professional, career, and academic reports for entities based on entity related data collection and public, private, professional, career, and academic data isolation techniques as similarly described herein with respect to various embodiments. In some embodiments, platform 102 includes components as similarly described above with respect to FIG. 4 in addition to the professional, career, and academic reporting engine 602 that can report on the verified public, private, professional, career, and academic data associated with an entity that was collected and extracted, as further described below.

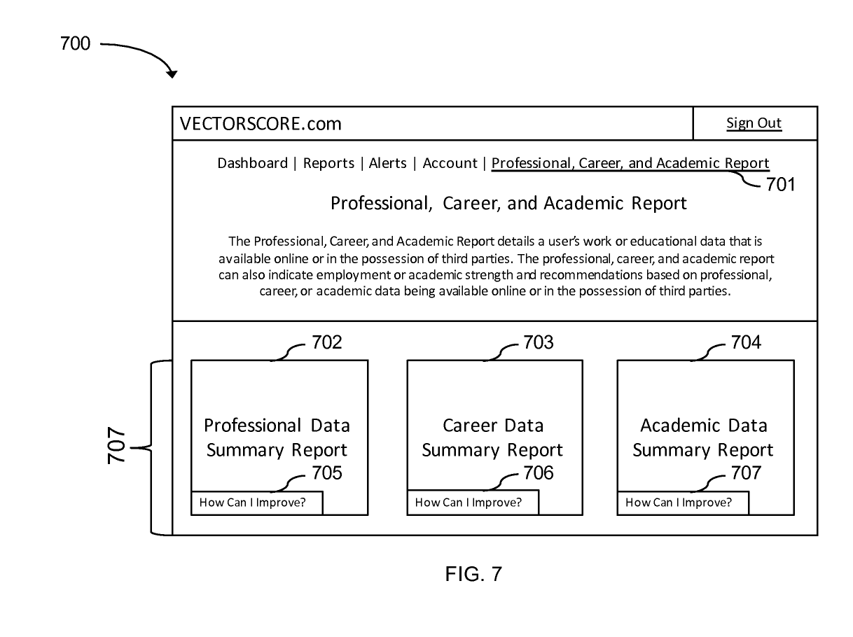

In some embodiments, professional, career, and academic reporting performed by private or public platform 102 includes collecting information associated with an entity (e.g., David, Helen, or another entity); and generating a professional, career, and academic report based on private information that was collected that is associated with the entity. In some embodiments, professional, career, and academic reporting further includes outputting the professional, career, and academic report, such as shown in FIG. 7 as described below.

FIG. 7 illustrates an example of an interface as rendered in a browser of a professional, career, and academic report in accordance with some embodiments. In particular, David is presented with interface 700 after logging in to his account on platform 102 using a browser application on client device 109 and clicking on tab option 701 for a professional, career, and academic report. In some embodiments, whenever David accesses platform 102 (and/or based on the elapsing of a certain amount of time), the professional, career, and academic report shown in FIG. 7 is refreshed. In particular, professional, career, and academic reporting engine 602 retrieves, from database 208 (e.g., or from memory based on a recollection process as similarly discussed above), public or private data pertaining to David and generates the professional, career, and academic report shown in FIG. 7. Example ways of providing a professional, career, and academic report are as follows.

In region 707 of interface 700, various professional, career, and academic report data are presented including various summary reports for different categories of professional, career, and academic data. In particular, the summary reports provide David with a quick perspective on what public, private, professional, career, and academic information associated with David is available online or in the possession of third parties. Three example categories are shown in region 707, each of which is discussed below. A category 702 for professional related professional, career, and academic data summary report is provided to indicate to David what professional related private data (e.g., work history, salary data, professional certifications, and/or other professional related professional, career, and academic data) is available online or in the possession of third parties. A category 703 for career related professional, career, and academic data summary report is provided to indicate to David what career related professional, career, and academic data (e.g., responsibility level, direct reporting, career progression, and/or other career related professional, career, and academic data) is available online or in the possession of third parties. A category 705 for tracker academic summary report is provided to indicate to David what academic information may be available and what professional, career, and academic data such academic transcripts may have obtained and how that professional, career, and academic data may be used by such application systems.

In some embodiments, the summary reports include links or drill-down options to view more information, such as regarding a particular set of professional, career, and academic data that was collected, a particular source of such professional, career, and academic data, and how such professional, career, and academic data may be used by the source or other third parties (e.g., based on stated policies associated with such third parties, past behaviors of such third parties, inferences, and/or other techniques). In some embodiments, for each category, David can see tips on how to improve his professional, career, and academic data access online and/or with third parties by clicking on an appropriate box (e.g., boxes 702-705 for tips on improving professional, career, and academic competitiveness). Example recommendations can include identifying areas of professional improvement such as increasing certifications or furthering education, such as attending graduate school to achieve a master of business administration. In some embodiments, such boxes are only displayed for professional, career, and academic issues that can/should be improved.

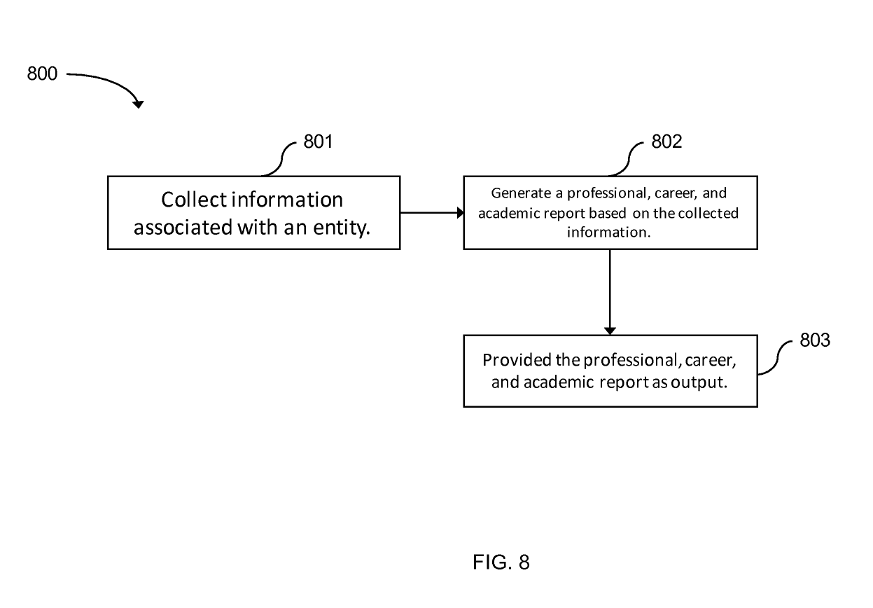

FIG. 8 illustrates a flow diagram of a process for professional, career, and academic reporting in accordance with some embodiments. In some embodiments, process 800 is performed by platform 102. The process begins at 801 when data obtained from each of a plurality of sites/sources is received. In particular, at 801, information associated with an entity is collected. As an example, process 800 begins at 801 when David logs into platform 102 and, in response, reporting engine 601 retrieves public, private, professional, career, and academic data associated with David from database 208. In addition to generating professional, career, and academic reports on demand, professional, career, and academic reports can also be generated as part of a batch process. As one example, professional, career, and academic reports across a set or group/class of users can be generated once a week. In such situations, the process begins at 801 when the designated time to perform the batch process occurs and data is received from database 208. In various embodiments, at least some of the data received at 801 is obtained on-demand directly from the sources/sites (instead of or in addition to being received from a storage, such as database 208).

At 802, a professional, career, and academic report for the entity based on the collected information is generated (e.g., using professional, career, and academic reporting engine 601). Various techniques for generating professional, career, and academic reports are discussed above. Other approaches can also be used, such as by generating a professional, career, and academic report for each of the categories of professional, career, and academic data associated with David to provide a composite report based on those category reports.

Finally, at 803, the professional, career, and academic score is output (e.g., using interface 700). As an example, a professional, career, and academic report is provided as output in region 707 of interface 700. As another example, professional, career, and academic reporting engine 601 can be configured to send professional, career, and academic reports to users via email (e.g., using an alerting engine, such as alerter 410).

As will now be apparent to one of ordinary skill in the art in view of the embodiments described herein, various other forms of professional, career, and academic reporting can be output using the professional, career, and academic scoring platform and various techniques described herein. For example, a timeliness factor can also be reported to indicate a last time a source was visited for professional, career, and academic data collection. As another example, information about sources determined to have public, private, professional, career, and academic data associated with the entity can also be reported (e.g., a reputation of such sources in terms of how such sources use professional, career, and academic data of users). Further, the various professional, career, and academic factors described above need not all be presented or output in the professional, career, and academic report nor need they be employed in the manners described herein. Additional factors can also be used when generating a professional, career, and academic report.

In some embodiments, a professional, career, and academic report is provided that also includes a professional, career, and academic score to provide a scoring based metric to inform an entity of their professional, career, and academic competitiveness.

### Professional, Career, and Academic Scoring

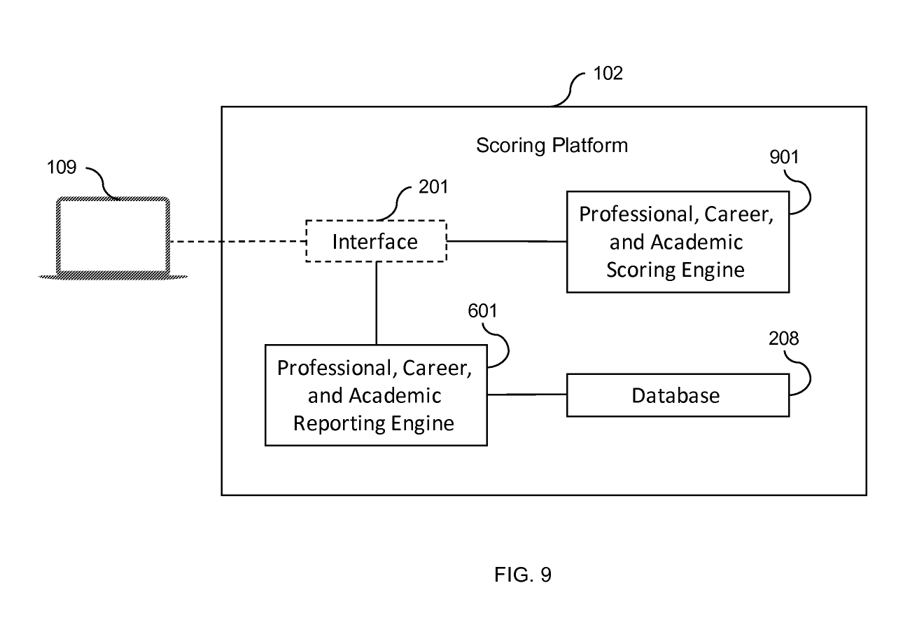

An example computation of a professional, career, and academic score that can be included in a professional, career, and academic report is discussed below in conjunction with FIGS. 9-11.

FIG. 9 illustrates an example of components included in a professional, career, and academic platform that performs professional, career, and academic scoring in accordance with some embodiments. In particular, FIG. 9 illustrates components of platform 102 that are used in conjunction with generating professional, career, and academic scores. In some embodiments, platform 102 includes a professional, career, and academic reporting engine 601 that generates professional, career, and academic reports for entities based on entity related data collection and public, private, professional, career, and academic data isolation techniques as similarly described herein with respect to various embodiments. In some embodiments, platform 102 also includes a professional, career, and academic engine 901 that generates professional, career, and academic for entities based on entity related data collection and public, private, professional, career, and academic data isolation techniques as similarly described herein with respect to various embodiments. In some embodiments, professional, career, and academic reporting engine and professional, career, and academic scoring engine are used in coordination to generate a professional, career, and academic report that includes a professional, career, and academic score. In some embodiments, platform 102 includes components as similarly described above with respect to FIG. 4 in addition to the professional, career, and academic reporting engine 601 and professional, career, and academic scoring engine 901 that can report on the verified professional, career, and academic data associated with an entity that was collected and extracted, as further described below.

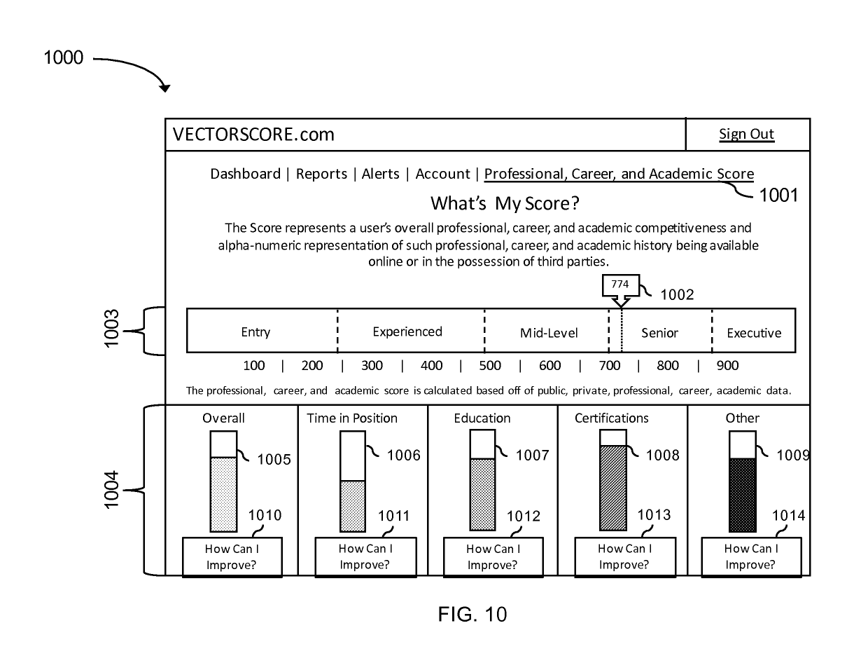

FIG. 10 illustrates an example of an interface as rendered in a browser of a professional, career, and academic report with a professional, career, and academic score in accordance with some embodiments. In particular, David is presented with interface 1000 after logging in to his account on platform 102 using a browser application on client device 106 and clicking on tab option 1001 for a professional, career, and academic score.

In some embodiments, whenever David accesses platform 102 (and/or based on the elapsing of a certain amount of time), the composite score shown at 1002 in FIG. 10 is refreshed. In particular, professional, career, and academic scoring engine 901 retrieves, from database 208, professional, career, and academic data pertaining to David and generates the various professional, career, and academic scores shown in FIG. 10. Example ways of computing a composite -professional, career, and academic score are discussed below. Also, as will be described in more detail below, users are able to explore the factors that contribute to their professional, career, and academic scores by manipulating various interface controls, and they can also learn how to improve their scores.

In region 1002 of interface 1000, a composite professional, career, and academic score (774 points in this example) is depicted on a scale 1003 as shown. Example ways of computing a composite professional, career, and academic score are described below. The composite professional, career, and academic score provides David with a quick perspective, for example, on David's professional, career, and academic competitiveness. A variety of factors can be considered in determining a composite professional, career, and academic score. Five example factors are shown in region 1004, each of which is discussed below.

For each factor, David can see tips on how to improve his score with respect to that factor by clicking on the appropriate box (e.g., box 1010 for tips on improving score 1005). In the example shown in FIG. 10, a recommendation box is present for each score presented in region 1004. In some embodiments, such boxes are only displayed for scores that can/should be improved. For example, given that score 1008 is already very high, in some embodiments, box 1013 is omitted from the interface as displayed to David, or an alternate message is displayed, such as “you have maximized your competitiveness.”

Overall Score (1005): This value reflects the average or composite professional, career, and academic score across all categories. As shown, if David clicks on box 1010, he will be presented with a suggestion(s), such as a list of recommendations to improve David's overall professional, career, and academic score and maximize his professional and/and academic competitiveness. In some embodiments, personalized advice may also be provided, such as recommending to David that he subscribe to automated professional, career, and academic competitiveness alerts. In some embodiments, automated professional, career, and academic reporting alerts and/or professional, career, and academic scoring alerts are provided as a subscription service. In some embodiments, automated professional, career, and academic reporting alerts and/or professional, career, and academic scoring alerts are provided as a free service (e.g., for a limited period of time).

As also shown in FIG. 10, various other categories of professional, career, and academic competitiveness scoring are presented in section 1004 of interface 1000, as discussed further below.

Time in Position (1006): This score indicates risks associated with the time an entity or user is in a position, employed or unemployed.

Education (1007): This score indicates a mix of the level of education an entity or user has attained, bachelor or master's degree, time since last education, or quality of university.

Certifications (1008): This score indicates a certification, such as Project Management Professional (PMP), relevancy to the entity or user's professional, career, and academic progression.

Other (1009): This score indicates professional, career, and academic factors with various other professional, career, and academic related data, such as salary related professional, career, and academic data and/or other professional, career, and academic related data. In some embodiments, entities, such as David, can configure their account to identify new categories of interest, such as location or other categories that David may deem to be professional, career, and academic data that can be monitored by the scoring platform disclosed herein. For example, by clicking on box 1014, David will be presented with an appropriate suggestion(s) for improvement.

In various embodiments of interface 1000, additional controls for interactions are made available. For example, a control can be provided that allows a user to see specific extractions of professional, career, and academic data and their source(s)—including professional, career, and academic data from sources that contributed the most to/deviated the most from the overall score (and/or individual factors). As one example, a third party source that is weighted heavily in the calculation of a score or scores can be identified and presented to the user. The user could then attempt to understand the user's professional, career, and academic data by that third party source, such as by using a service offered by a service provider such as VectorScore.com to assist the user to apply to professional and academic programs with the ability to understand the user's competiveness off of a given a metric.

A variety of weights can be assigned to the above factors when generating the composite score shown in region 1002. Further, the factors described above need not all be employed nor need they be employed in the manners described herein. Additional factors can also be used when generating a composite score. An example computation of a composite score is discussed below. In some embodiments, scoring engine 901 computes a base score that is a weighted average of all of the professional, career, and academic data related risks identified in each category of professional, career, and academic competitiveness, such as shown in FIG. 10 and discussed above. In some embodiments, certain categories are more heavily weighted, such as time in position, than other categories, such as education. In some embodiments, certain types of professional, career, and academic data points are more heavily weighted, such as certifications or company size derived from a third party (e.g., if a particular third party had company or salary information about a user), than other types of professional, career, and academic data, such as managerial responsibility related information.

As explained above, a variety of techniques can be used by scoring engine 901 in determining professional, career, and academic scores. In some embodiments, scores for all types of entities are computed using the same sets of rules. In other embodiments, professional, career, and academic score computation varies based on type of entity, category of user (e.g., profession, geography, and/or other categorization of users), configured criteria by the entity for that account (e.g., David can input custom configurations for his professional, career, and academic reporting and professional, career, and academic scoring for his account), geography of the entity, and/or other factors or considerations (e.g., professional, career, and academic scores for adults using one approach and/or one set of factors, and professional, career, and academic scores for doctors using a different approach and/or different set of factors). Scoring engine 901 can be configured to use a best in class entity when determining appropriate thresholds/values for entities within a given categorization. The following are yet more examples of factors that can be used in generating professional, career, and academic scores.

In some embodiments, the professional, career, and academic score is based on a scale, which is open ended score (e.g., the professional, career, and academic score becomes higher as more verified information for David becomes verified and is accessed by third parties). In some embodiments, marketing companies that are determined to have access to professional, career, and academic information are weighted based on reputation and ranking of education, company size, time in current position, and/other analysis on such entities (e.g., the professional, career, and academic platform can allocate different reputations to different third party data sources, such as LinkedIn, Facebook, and/or other sources based on such criteria).

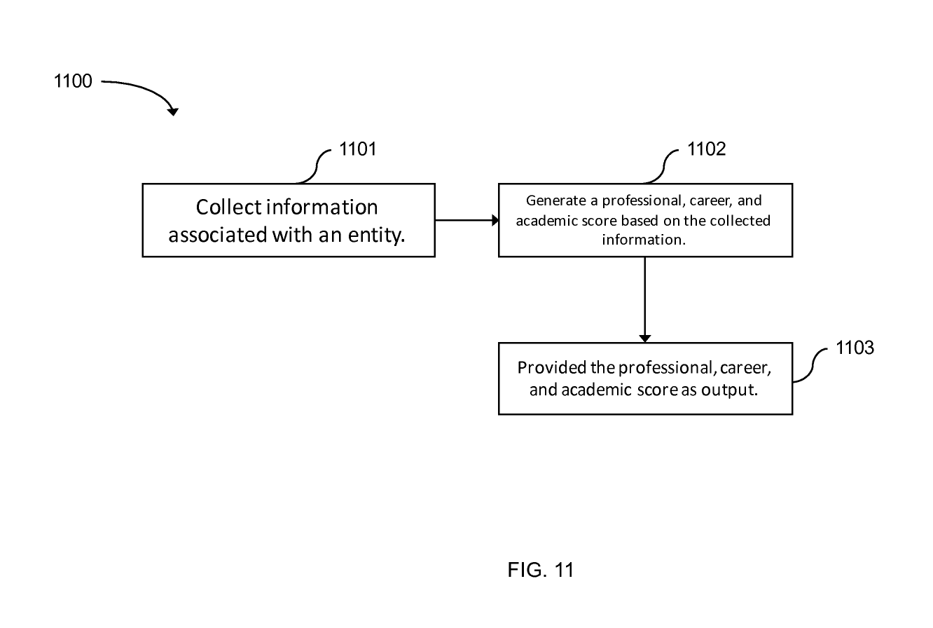

FIG. 11 illustrates a flow diagram of a process for professional, career, and academic scoring in accordance with some embodiments. In some embodiments, process 1100 is performed by platform 102. The process begins at 1101 when data obtained from each of a plurality of sites/sources is received. In particular, at 1101, information associated with an entity is collected. As one example, process 1100 begins at 1101 when David logs into platform 102 and, in response, scoring engine 901 retrieves professional, career, and academic data associated with David from database 208. In addition to generating professional, career, and academic scores on demand, professional, career, and academic scores can also be generated as part of a batch process. As one example, scores across a set or group/class of users can be generated (e.g., for benchmark purposes) once a week. In such situations, the process begins at 1101 when the designated time to perform the batch process occurs and data is received from database 208. In various embodiments, at least some of the data received at 1101 is obtained on-demand directly from the sources/sites (instead of or in addition to being received from storage, such as database 208).

At 1102, a professional, career, and academic score for the entity based on the collected information is generated (e.g., using professional, career, and academic scoring engine 901). Various techniques for generating professional, career, and academic scores are discussed above. Other approaches can also be used, such as by determining an average score for each of the categories of professional, career, and academic data associated with David and combining those average scores (e.g., by multiplying or adding them and normalizing the result).

Finally, at 1103, the professional, career, and academic score is output (e.g., using interface 1000). As one example, a professional, career, and academic score is provided as output in region 1002 of interface 1000. As another example, scoring engine 901 can be configured to send professional, career, and academic scores to users via email (e.g., using an alerting engine, such as alerter 410).

As will now be apparent to one of ordinary skill in the art in view of the embodiments described herein, various other forms of professional, career, and academic scoring can be generated and output using the scoring platform and various techniques described herein. For example, information about sources determined to have professional, career, and academic data associated with the entity can also be used to impact a professional, career, and academic score (e.g., a reputation of such sources in terms of how such sources use public, private, professional, career, and academic data of users can be used as relative weight in the professional, career, and academic score in which a lower professional, career, and academic score can result from a third party having professional, career, and academic data of a user). Further, the various professional, career, and academic factors described above need not all be presented or output in the professional, career, and academic score nor need they be employed in the manners described herein. Additional factors can also be used when generating a professional, career, and academic score. Also, various other forms of scoring or scaling can also be used, such as letter grades, scales that are commensurate with credit scoring, and/or various other approaches using the professional, career, and academic platform and techniques disclosed herein.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A system for professional, career, and academic scoring, comprising:
a processor configured to:
collect information associated with an entity from a plurality of sources, wherein the plurality of sources includes at least one third party source, and wherein the collected information includes public, private, professional, career, and academic information associated with the entity; and
perform a professional, career, and academic competitiveness analysis based at least in part on the collected public, private, professional, career, and academic information, wherein the competitiveness analysis includes determining types of public, private, professional, career, and academic information included in the collected public, private, professional, career, and academic information, and wherein performing the competitiveness analysis includes evaluating the public, private, professional, career, and academic information to determine professional, career, and academic competitiveness associated with the entity with respect to a plurality of categories;
generate a professional, career, and academic score based at least in part on the competitiveness analysis, wherein the professional, career, and academic score comprises a composite professional, career, and academic score across the plurality of categories, and wherein the composite professional, career, and academic score is based at least in part on a base score that is a weighted average of at least a portion of the professional, career, and academic data determined with respect to the plurality of categories; and
a memory coupled to the processor and configured to provide the processor with instructions.

2. The system recited in claim 1, wherein the processor is further configured to:
determine, from the collected information, the public, private professional, career, and academic information associated with the entity.

3. The system recited in claim 1, wherein the processor is further configured to:
output the professional, career, and academic score.

4. The system recited in claim 1, wherein the processor is further configured to:
output a professional, career, and academic report that includes the professional, career, and academic score.

5. The system recited in claim 1, wherein the processor is further configured to:
output a professional, career, and academic report that includes the professional, career, and academic score, wherein the professional, career, and academic score corresponds to an overall professional, career, and academic score.

6. The system recited in claim 1, wherein the processor is further configured to:
output a professional, career, and academic report that includes the professional, career, and academic score and a recommendation to improve the professional, career, and academic score.

7. The system recited in claim 1, wherein the processor is further configured to:
alert the entity based on the professional, career, and academic score.

8. The system recited in claim 1, wherein the processor is further configured to:
periodically collect information associated with the entity; and
update the professional, career, and academic score.

9. The system recited in claim 1, wherein the processor is further configured to:
periodically collect information associated with the entity;
update the professional, career, and academic score; and
alert the entity that the professional, career, and academic score has been updated.

10. A method for professional, career, and academic scoring, comprising:
collecting information associated with an entity from a plurality of sources, wherein the plurality of sources includes at least one third party source, and wherein the collected information includes public, private, professional, career, and academic information associated with the entity; and
performing a competitiveness analysis based at least in part on the collected public, private, professional, career, and academic information, wherein the competitiveness analysis includes determining types of public, private, professional, career, and academic information included in the collected public, private, professional, career, and academic information, and wherein performing the competitiveness analysis includes evaluating the public, private, professional, career, and academic information to determine professional, career, and academic data associated with the entity with respect to a plurality of categories;
generating, using a computer processor, a professional, career, and academic score based at least in part on the competitiveness analysis, wherein the professional, career, and academic score comprises a composite professional, career, and academic score across the plurality of categories, and wherein the composite professional, career, and academic score is based at least in part on a base score that is a weighted average of at least a portion of the professional, career, and academic data determined with respect to the plurality of categories.

11. The method of claim 10, further comprising:
determining, from the collected information, the public, private, professional, career, and academic information associated with the entity.

12. The method of claim 10, further comprising:
outputting the professional, career, and academic score.

13. The method of claim 10, further comprising:
outputting a professional, career, and academic report that includes the professional, career, and academic score.

14. The method of claim 10, further comprising:
outputting a professional, career, and academic report that includes the professional, career, and academic score, wherein the professional, career, and academic score corresponds to an overall professional, career, and academic score.

15. The method of claim 10, further comprising:
outputting a professional, career, and academic report that includes the professional, career, and academic score and a recommendation to improve the professional, career, and academic score.

16. A computer program product for professional, career, and academic scoring, the computer program product being embodied in a non-transitory computer readable storage medium and comprising computer instructions for:
collecting information associated with an entity from a plurality of sources, wherein the plurality of sources includes at least one third party source, and wherein the collected information includes public, private, professional, career, and academic information associated with the entity; and
performing a competitiveness analysis based at least in part on the collected public, private, professional, career, and academic information, wherein the competitiveness analysis includes determining types of public, private, professional, career, and academic information included in the collected public, private, professional, career, and academic information, and wherein performing the competitiveness analysis includes evaluating the public, private, professional, career, and academic information to determine professional, career, and academic data associated with the entity with respect to a plurality of categories;
generating a professional, career, and academic score based at least in part on the competitiveness analysis, wherein the professional, career, and academic score comprises a composite professional, career, and academic score across the plurality of categories, and wherein the composite professional, career, and academic score is based at least in part on a base score that is a weighted average of at least a portion of the professional, career, and academic data determined with respect to the plurality of categories.

17. The computer program product recited in claim 16, further comprising computer instructions for:
determining, from the collected information, the private information associated with the entity.

18. The computer program product recited in claim 16, further comprising computer instructions for:
outputting the professional, career, and academic score.

19. The computer program product recited in claim 16, further comprising computer instructions for:
outputting a professional, career, and academic report that includes the professional, career, and academic score.

20. The computer program product recited in claim 16, further comprising computer instructions for:
outputting a professional, career, and academic report that includes the professional, career, and academic score, wherein the professional, career, and academic score corresponds to an overall professional, career, and academic score.
